SEQUENCE LISTING (2 sequences)

SEQ ID NO: 1 - DNA, 12 bp, Artificial sequence
  Chemically synthesized
gctggaaggcat

SEQ ID NO: 2 - DNA, 10 bp, Artificial sequence
  Chemically synthesized
gcagagcact

(19) United States
(12) Patent Application Publication
(10) Pub. No.: US 2009/0287755 A1
(43) Pub. Date: Nov. 19, 2009

(54) SEQUENCE SIMILARITY MEASURING APPARATUS AND CONTROL METHOD THEREOF

(76) Inventors: Jae Kwang Kim, Gyeonggi-do (KR); Jee Hyong Lee, Seoul (KR); Tae Bok Yoon, Kyonggi-do (KR); Dong Moon Kim, Kyonggi-do (KR); Jung Hoon Kim, Kyonggi-do (KR); Dong Hoon Lee, Gyeonggi-do (KR); Kun Su Kim, Kyonggi-do (KR); Je Hee Jung, Kyonggi (KR); Seung Hoo Lee, Kyonggi-do (KR); Kwang Ho Yoon, Seoul (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/274,376

(22) Filed: Nov. 20, 2008

(30) Foreign Application Priority Data
May 13, 2008 (KR) 10-2008-0044064

(51) Int. Cl. G06F 17/15; G06F 7/32

(52) U.S. Cl. 708/422; 708/520

(57) ABSTRACT

Disclosed is a sequence similarity measuring apparatus and a method of controlling the same. The sequence similarity measuring apparatus using dynamic programming includes: a matrix generating unit for generating a matrix based on the dynamic programming by using two sequences; a normalization unit for calculating a similarity reference value by inputting an element value of a last row/column of the matrix generated by the matrix generating unit into a normalization formula for a given sequence length; and a similarity measuring unit for measuring predefined sequence similarity between the two sequences, based on the similarity reference value calculated by the normalization unit. This makes it possible to easily and correctly achieve similarity comparison between multiple sequences, and thus this technology is expected to be widely utilized in biology/programming application fields.

### BACKGROUND OF THE INVENTION

1. Field of the Invention

The present invention relates to an apparatus for measuring sequence similarity and a method of controlling the same. More particularly, the present invention relates to an apparatus for measuring sequence similarity, which is capable of measuring similarity between multiple sequences regardless of their lengths, through matrix generation based on dynamic programming by using two sequences to be measured, and given normalization on an element value of a last row/column of a corresponding matrix, and a method of controlling the same.

2. Description of the Prior Art

A sequence comparison algorithm using dynamic programming has been widely used for comparison of a biological cell sequence (including DNA, RNA, and protein) and similarity measurement of programming source codes.

In order to compare two sequences, firstly, a matrix based on dynamic programming is generated by using the two sequences. In generating a matrix, element values of each matrix are calculated as follows: an element value in a row, column, or diagonal position, which is most adjacent to a base value of each matrix, is obtained by using dynamic programming, and an element value in a last row/column is obtained (matrix formation by using conventional dynamic programming). Herein, from the comparison of element values of a last row/column of a matrix on two sequences, the matrix being generated based on dynamic programming, it has been known that similarity between two sequences is higher as the element value of the last row/column is higher.

In comparison of similarity between two sequences by using conventional dynamic programming, there is a problem in that it is impossible to correctly measure similarity in the case where there are multiple sequences having different lengths. This is because an element value of a last row/column of a matrix on two sequences varies according to the length of each sequence, and the element value of the last row/column of the matrix is higher as the lengths of the two sequences are longer.

### SUMMARY OF THE INVENTION

Accordingly, the present invention has been made to solve the above-mentioned problems occurring in the prior art, and the present invention provides an apparatus for measuring sequence similarity, which is capable of measuring similarity between sequences regardless of their lengths, and a method of controlling the same.

In other words, the present invention provides a sequence similarity measuring apparatus and a method of controlling the same, in which similarity between sequences is measured by generating a matrix based on dynamic programming by using two sequences to be measured, and by carrying out normalization on a last row/column element value of the matrix with respect to a given sequence length.

In accordance with an aspect of the present invention, there is provided an apparatus for measuring sequence similarity by using dynamic programming, the apparatus including: a matrix generating unit for generating a matrix based on the dynamic programming by using two sequences; a normalization unit for calculating a similarity reference value by inputting an element value of a last row/column of the matrix generated by the matrix generating unit into a normalization formula for a given sequence length; and a similarity measuring unit for measuring predefined sequence similarity between the two sequences based on the similarity reference value calculated by the normalization unit.

Preferably, a normalization formula for the sequence length is for calculating the similarity reference value in proportion to the element value of the last row/column of the matrix and an average of reciprocals of lengths of the two sequences to be measured.

Preferably, herein, the sequences include a biological cell sequence including DNA, RNA, and protein, and a programming source code sequence.

In accordance with another aspect of the present invention, there is provided a method of controlling a sequence similarity measuring apparatus based on dynamic programming, the method including the steps of: (a) generating a matrix based on dynamic programming by using two sequences; (b) calculating a similarity reference value by inputting an element value of a last row/column of the matrix into a normalization formula for a given sequence length; and (c) measuring predefined similarity between the two sequences based on the similarity reference value.

Preferably, step (b) uses normalization formula for the sequence length which is in proportion to the element value of the last row/column of the matrix and an average of reciprocals of lengths of the two sequences to be measured.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a sequence similarity measuring apparatus according to an embodiment of the present invention;

FIG. 2 illustrates matrix generation by a sequence similarity measuring apparatus according to an embodiment of the present invention; and

FIG. 3 is a flow diagram illustrating a method of controlling a sequence similarity measuring apparatus according to an embodiment of the present invention.

### DETAILED DESCRIPTION OF THE EXEMPLARY EMBODIMENTS

Hereinafter, an exemplary embodiment of the present invention will be described with reference to the accompanying drawings.

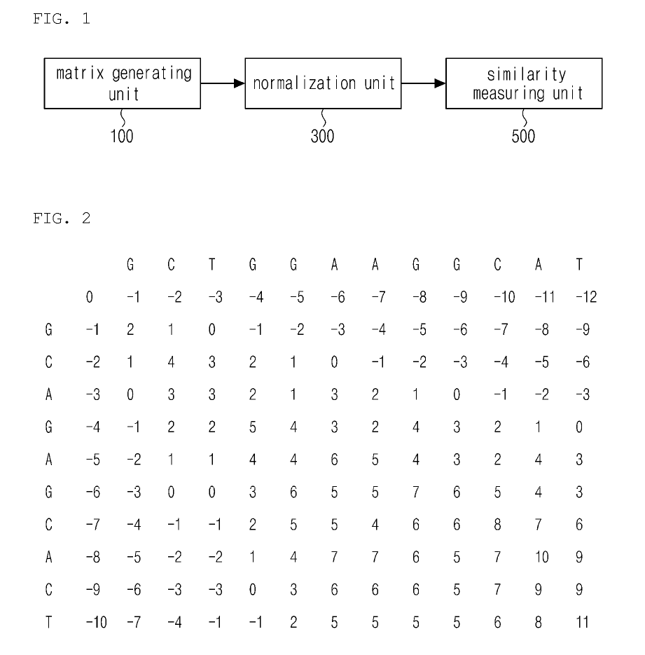

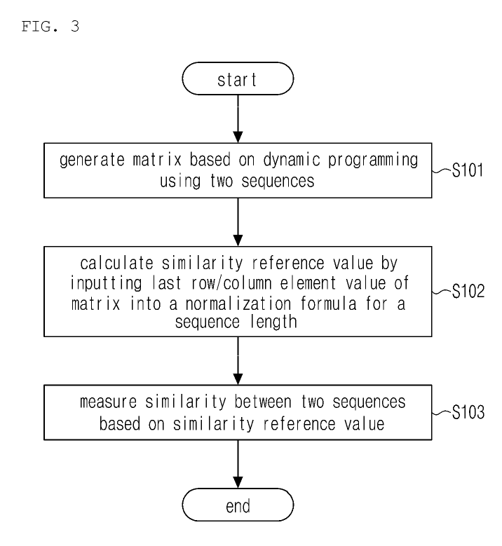

FIG. 1 is a block diagram illustrating a sequence similarity measuring apparatus according to an embodiment of the present invention. FIG. 2 illustrates matrix generation by a sequence similarity measuring apparatus according to an embodiment of the present invention.

Referring to FIG. 1, the sequence similarity measuring apparatus according to an embodiment of the present invention includes a matrix generating unit 100, a normalization unit 300, and a similarity measuring unit 500.

The matrix generating unit 100 generates a matrix based on dynamic programming by using two sequences to be measured. The dynamic programming indicates a technique which has been used for comparison of a biological cell sequence and similarity measurement of programming source codes. Herein, the term “sequence” includes a sequence of a biological cell including DNA, RNA, and protein, and a sequence of programming source codes.

Hereinafter, matrix generation based on dynamic programming by using two sequences will be described in detail with reference to FIG. 2.

For example, when two sequences to be measured are as follows: “G C T G G A A G G C A T” and “G C A G A G C A C T”,

G C T G G A A G G C A T
G C A G A G C A C T,

as shown in FIG. 2, an element value in a row, column, or diagonal position, which is most adjacent to a base value of each matrix, can be obtained based on dynamic programming (in matrix formation by using conventional dynamic programming).

Meanwhile, an element value of the last row/column in the matrix shown in FIG. 2 (for example, “11” in FIG. 2) may be higher as a sequence length is longer, which causes a problem in similarity comparison between multiple sequences having different lengths. Thus, it is required to use the following normalization unit 300 to normalize the element value of the last row/column.

The normalization unit 300 normalizes a certain element value of a matrix in order to compare similarity between multiple sequences, in which an element value (a lastly generated value based on dynamic programming) of a last row/column of a matrix generated by the matrix generating unit 100 is substituted into a normalization formula for a given sequence length to calculate a similarity reference value.

The normalization formula for the given sequence length is for calculating a similarity reference value which is in proportion to an element value of a last row/column (in a matrix generated based on dynamic programming by using two sequences) and an average of reciprocals of lengths of the two sequences to be measured: “Vₙₒᵣ=Vₘₐₓ*(1/SL_{A}+1/SL_{B})/2” (Vₙₒᵣ indicates a similarity reference value, Vₘₐₓ indicates the last element value of the last row/column of the above mentioned matrix, and SL_{A} and SL_{B} indicate lengths of sequences A and B). The above mentioned normalization formula for the sequence length is based on the principle in which an element value of a last row/column of a matrix is divided by a sequence length so as to achieve normalization regardless of lengths of multiple sequences to be measured. Accordingly, since there are two sequences to be measured, the similarity reference value (Vₙₒᵣ) can be calculated by multiplying an average of reciprocals of respective sequence lengths by an element value of a last row/column of a matrix.

Meanwhile, the above mentioned normalization formula for the sequence length may be represented by “Vₙₒᵣ=Vₘₐₓ* (1/SL_{A}+1/SL_{B})/2”.

The similarity measuring unit 500 can measure predefined sequence similarity between two sequences to be measured, based on a similarity reference value calculated by the normalization unit 300. Herein, the predefined sequence similarity is a value corresponding to a similarity reference value normalized and calculated by the normalization unit 300. Thus, it can be said that as the similarity reference value is higher, similarity between two sequences to be measured is higher. The similarity reference value is based on the fact that an element value of a last row/column of a matrix is normalized and is used as a reference value.

FIG. 3 is a flow diagram illustrating a method of controlling a sequence similarity measuring apparatus according to an embodiment of the present invention.

Hereinafter, operation procedures in a method of controlling the sequence similarity measuring apparatus according to an embodiment of the present invention will be described with reference to FIG. 3.

A matrix based on dynamic programming is generated by using two sequences in step S101. The matrix based on dynamic programming is generated in the same manner as described above.

An element value (Vₘₐₓ) of a last row/column of the matrix is substituted into the above mentioned normalization formula for the sequence length to calculate a similarity reference value (Vₙₒᵣ) in step S102. Herein, the normalization formula for the sequence length is based on the principle in which an element value of a last row/column of a matrix is divided by a sequence length so as to achieve normalization regardless of lengths of multiple sequences to be measured. Herein, the detailed description of the formula will be omitted because it has been already explained.

Similarity between two sequences is measured in step S103 based on the calculated similarity reference value.

As described above, it is expected that since similarity between two sequences is measured based on a similarity reference value normalized by using a normalization formula for the sequence length, it is possible to measure sequence similarity regardless of lengths of multiple sequences to be measured.

Although an exemplary embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

According to the present invention, it is possible to correctly measure similarity between multiple sequences having different lengths by normalizing a last row/column element value of a matrix based on dynamic programming, the matrix being generated to compare similarity between two sequences. This makes it possible to easily and correctly achieve similarity comparison between multiple sequences, and thus this technology is expected to be widely utilized in biology/programming application fields.

The present invention relates to an apparatus for measuring sequence similarity and a method of controlling the same. More particularly, the present invention relates to an apparatus for measuring sequence similarity, which is capable of measuring similarity between multiple sequences regardless of their lengths, through matrix generation based on dynamic programming by using two sequences to be measured, and given normalization on an element value of a last row/column of a corresponding matrix, and a method of controlling the same.

What is claimed is:

1. An apparatus for measuring sequence similarity by using dynamic programming, the apparatus comprising:
a matrix generating unit for generating a matrix based on the dynamic programming by using two sequences;
a normalization unit for calculating a similarity reference value by inputting an element value of a last row/column of the matrix generated by the matrix generating unit into a normalization formula for a given sequence length; and
a similarity measuring unit for measuring the predefined sequence similarity between the two sequences, based on the similarity reference value calculated by the normalization unit.

2. The apparatus as claimed in claim 1, wherein the normalization formula for the sequence length is characterized by calculating the similarity reference value in proportion to the element value of the last row/column of the matrix and an average of reciprocals of lengths of the two sequences to be measured.

3. The apparatus as claimed in claim 1, wherein the sequences comprise a biological cell sequence comprising DNA, RNA, and protein, and a programming source code sequence.

4. A method of controlling a sequence similarity measuring apparatus based on dynamic programming, the method comprising the steps of:
(a) generating a matrix based on the dynamic programming by using two sequences;
(b) calculating a similarity reference value by inputting an element value of a last row/column of the matrix into a normalization formula for a given sequence length; and
(c) measuring the predefined similarity between the two sequences based on the similarity reference value.

5. The method as claimed in claim 4, wherein the step (b) is characterized by using the normalization formula for the sequence length in proportion to the element value of the last row/column of the matrix and an average of reciprocals of lengths of the two sequences to be measured.

6. The apparatus as claimed in claim 2, wherein the sequences comprise a biological cell sequence comprising DNA, RNA, and protein, and a programming source code sequence.
